(19) United States
(12) Patent Application Publication
(10) Pub. No.: US 2003/0222754 A1
(43) Pub. Date: Dec. 4, 2003

(54) Vehicle control and security system

(76) Inventor: Yong Min Cho, Silver Spring, MD (US)

Correspondence Address: Mr. Yong Min Cho, 16605 Sea Island Cosurt, Silver Spring, MD, 20905, US

(21) Appl. No.: 10/157,834

(22) Filed: May 31, 2002

(51) Int. Cl. G05B 19/00; H04Q 1/00

(52) U.S. Cl. 340/5.7

(57) ABSTRACT

Due to the September 11^{th} terrorist attacks, the United States has since had a heightened awareness of inefficient security systems. Once of these such inefficient systems are the parking lot security systems. Because safety is such an important issue concerning the restricted parking facilities of important facilities, such as government office buildings and nuclear power plants, the Vehicle Control and Security System has been designed to maximize parking security. Through a process of vehicle and driver identification to take place at both the entrances and exits of the parking lots, both the vehicle and driver would have to be recognized as authorized figures in order to enter the parking facility. If either the vehicle information or driver information comes back from the computer as an unauthorized vehicle or driver, the gate would not be lifted to allow the vehicle to enter the facility. This process would ensure maximum security.

### BACKGROUND OF THE INVENTION

Since the September 11^{th} terrorist attacks, safety has become an increasingly higher priority of all United States residents. Safety is an especially important issue concerning the restricted parking facilities of important facilities, such as government office buildings and nuclear power plants. The Radio Frequency (RF) vehicle identification system will ensure the highest security. The RF vehicle identification tag reader and wireless identification card reader will be installed in both the entrances and exits of parking facilities. In the entrance of these facilities, the RF vehicle identification tag reader will read a vehicle's identification tag and the wireless identification card reader will read the driver's authorized identification card. Once both the vehicle identification tag and the driver identification tag are verified as authorized passes, the vehicle will be allowed to enter the parking facilities. This same process will occur at the exit to ensure maximum security.

### SUMMARY OF THE INVENTION

The primary objective of this invention is to provide an efficient vehicle control and security system that is able to control and secure parking facilities. The parking facilities will be equipped with the wireless identification card readers and RF vehicle identification tag readers. Both readers, connected to a common computer, will need to verify their information as identical and as authorized. The vehicle will be equipped with a RF identification tag, and the driver will carry a wireless identification card. This system will provide complete protection and security from unauthorized vehicles and personnel.

### BRIEF DESCRIPTION OF THE DRAWING

This invention can be fully understood through references to the following figure and its brief descriptions below:

FIG. 1 is a conceptual view of the Vehicle Control and Security System

### DETAILED DESCRIPTION OF THE DRAWING

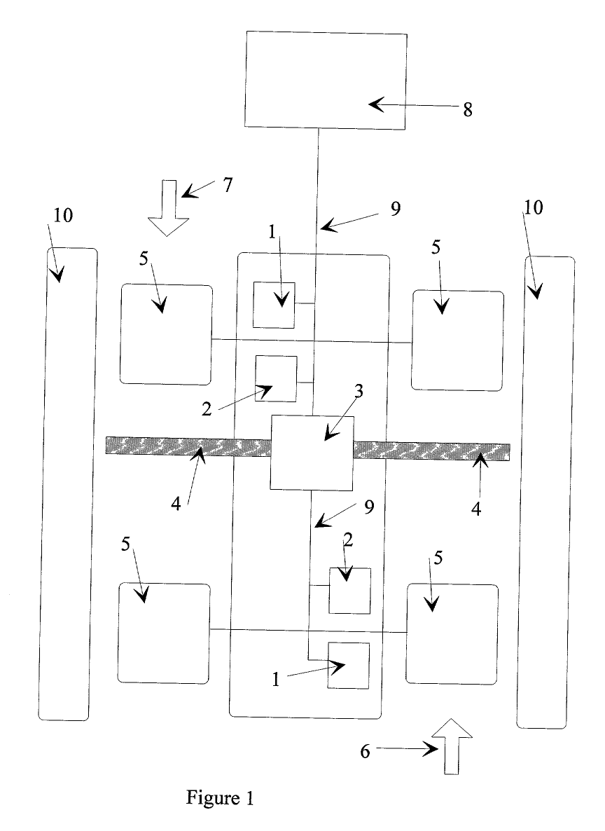

In FIG. 1, the RF vehicle identification tag readers 1 and wireless identification card readers 2 are installed at the entrance 6 and exit 7 of the parking facility. Underground loop coils 5 are also installed to detect the vehicles. The RF vehicle identification tag reader 1 and wireless identification card reader 2 are connected to the computer 8 through the network link 9. After correct verification of the vehicle identification tag and wireless identification card, the computer 8 will give the command to open the barrier gate 4 through the gate controller 3. The vehicle must approach the gate entrance 6 and exit 7 between the vehicle identification tag readers 1 and the guardrails 10 to ensure the reading distance range.

I claimed:

1. An entrance and exit of parking lot facilities that is designed to use both a radio frequency vehicle identification tag reader and a driver's authorized wireless identification card reader for control and monitoring the parking facilities.

2. Any number, shape and size of the entrance and exit of parking lot facilities cover of claimed 1.
